(19) United States
(12) Patent Application Publication
(10) Pub. No.: US 2025/0166166 A1
(43) Pub. Date: May 22, 2025

(54) SYSTEMS AND METHODS FOR DEFECT LOCATION BINNING IN CHARGED-PARTICLE SYSTEMS

(71) Applicant: ASML Netherlands B.V., Veldhoven (NL)

(72) Inventors: Shengcheng JIN, San Jose, CA (US); Yunbo GUO, San Jose, CA (US); Chen ZHANG, San Jose, CA (US)

(73) Assignee: ASML Netherlands B.V., Veldhoven (NL)

(21) Appl. No.: 18/838,459

(22) PCT Filed: Jan. 19, 2023
(86) PCT No.: PCT/EP2023/051286

§ 371 Date: Aug. 14, 2024

Related U.S. Application Data
(60) Provisional application No. 63/311,414, filed on Feb. 17, 2022.

(51) Int. Cl. G06T 7/00

(52) U.S. Cl. CPC G06T 7/001; G06T 7/0006; G06T 2207/10061; G06T 2207/20081; G06T 2207/30148

(57) ABSTRACT

Apparatuses, systems, and methods for providing beams for defect detection and defect location binning associated with a sample of charged particle beam systems. A method of image analysis may include obtaining an image of a sample, identifying a feature captured in the image of the sample, generating a template image from a design layout of the identified feature, comparing 5 the image of the sample with the template image, and processing the image based on the comparison. In some embodiments, a method of image analysis may include obtaining an image of a sample, identifying a feature captured in the obtained image of the sample, mapping the obtained image to a template image generated from a design layout of the identified feature, and analyzing the image based on the mapping.

### CROSS-REFERENCE TO RELATED APPLICATIONS

This application claims priority of U.S. application 63/311,414 which was filed on 17 Feb. 2022 and which is incorporated herein in its entirety by reference.

### FIELD

The description herein relates to the field of charged particle beam systems, and more particularly to systems and methods for detection and location binning of defects associated with a sample being inspected by a charged particle beam system.

### BACKGROUND

In manufacturing processes of integrated circuits (ICs), unfinished or finished circuit components are inspected to ensure that they are manufactured according to design and are free of defects. An inspection system utilizing an optical microscope typically has resolution down to a few hundred nanometers; and the resolution is limited by the wavelength of light. As the physical sizes of IC components continue to reduce down to sub-100 or even sub-10 nanometers, inspection systems capable of higher resolution than those utilizing optical microscopes are needed.

A charged particle (e.g., electron) beam microscope, such as a scanning electron microscope (SEM) or a transmission electron microscope (TEM), capable of resolution down to less than a nanometer, serves as a practicable tool for inspecting IC components having a feature size that is sub-100 nanometers. With a SEM, electrons of a single primary electron beam, or electrons of a plurality of primary electron beams, can be focused at locations of interest of a wafer under inspection. The primary electrons interact with the wafer and may be backscattered or may cause the wafer to emit secondary electrons. The intensity of the electron beams comprising the backscattered electrons and the secondary electrons may vary based on the properties of the internal and external structures of the wafer, and thereby may indicate whether the wafer has defects.

### SUMMARY

Embodiments of the present disclosure provide apparatuses, systems, and methods for defect detection and defect location binning associated with a sample of charged particle beam systems.

One aspect of the present disclosure is directed to a method of image analysis. The method may include obtaining an image of a sample, identifying a feature captured in the image of the sample, generating a template image from a design layout of the identified feature, comparing the image of the sample with the template image, and processing the image based on the comparison.

Another aspect of the present disclosure is directed to a system for image analysis. The system may include a controller including circuitry configured to cause the system to perform a method of image analysis. The controller may cause the system to obtain an image of a sample, identify a feature captured in the image of the sample, generate a template image from a design layout of the identified feature, compare the image of the sample with the template image, and process the image based on the comparison.

Another aspect of the present disclosure is directed to a non-transitory computer readable medium that stores a set of instructions that is executable by one or more processors of a computing device to cause the computing device to perform a method for image analysis. The method may include obtaining an image of a sample, identifying a feature captured in the image of the sample, generating a template image from a design layout of the identified feature, comparing the image of the sample with the template image, and processing the image based on the comparison.

Another aspect of the present disclosure is directed to a method of image analysis. The method may include obtaining an image of a sample, identifying a feature captured in the obtained image of the sample, mapping the obtained image to a template image generated from a design layout of the identified feature, and analyzing the image based on the mapping.

Another aspect of the present disclosure is directed to a system for image analysis. The system may include a controller including circuitry configured to cause the system to perform a method of image analysis. The controller may cause the system to obtain an image of a sample, identify a feature captured in the obtained image of the sample, map the obtained image to a template image generated from a design layout of the identified feature, and analyze the image based on the mapping.

Another aspect of the present disclosure is directed to a non-transitory computer readable medium that stores a set of instructions that is executable by one or more processors of a computing device to cause the computing device to perform a method for image analysis. The method may include obtaining an image of a sample, identifying a feature captured in the obtained image of the sample, mapping the obtained image to a template image generated from a design layout of the identified feature, and analyzing the image based on the mapping.

### BRIEF DESCRIPTION OF THE DRAWINGS

FIG. 1 is a schematic diagram illustrating an exemplary electron beam inspection (EBI) system, consistent with embodiments of the present disclosure.

FIG. 2 is a schematic diagram illustrating an exemplary multi-beam system that is part of the exemplary charged particle beam inspection system of FIG. 1, consistent with embodiments of the present disclosure.

FIG. 3 illustrates a flowchart representing an exemplary method of image analysis.

FIG. 4 illustrates a flowchart representing an exemplary method of image analysis, consistent with embodiments of the present disclosure.

FIG. 5A represents a flowchart of a process for generating an exemplary location template, consistent with embodiments of the present disclosure.

FIGS. 5B-5E illustrate schematic diagrams of the steps associated with the process for generating a location template as shown in FIG. 5A, consistent with embodiments of the present disclosure.

FIG. 6 is a schematic diagram illustrating a simulated template image generated from a location template, consistent with embodiments of the present disclosure.

FIG. 7 is a schematic diagram illustrating an exemplary layout of a mask pattern, consistent with embodiments of the present disclosure.

FIG. 8 is a schematic diagram of an exemplary system for defect detection and defect location binning, consistent with embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of apparatuses and methods consistent with aspects related to the subject matter recited in the appended claims. For example, although some embodiments are described in the context of utilizing electron beams, the disclosure is not so limited. Other types of charged particle beams may be similarly applied. Furthermore, other imaging systems may be used, such as optical imaging, photodetection, x-ray detection, extreme ultraviolet inspection, deep ultraviolet inspection, or the like.

Electronic devices are constructed of circuits formed on a piece of silicon called a substrate. Many circuits may be formed together on the same piece of silicon and are called integrated circuits or ICs. The size of these circuits has decreased dramatically so that many more of them can fit on the substrate. For example, an IC chip in a smart phone can be as small as a thumbnail and yet may include over 2 billion transistors, the size of each transistor being less than 1/1000th the size of a human hair.

Making these extremely small ICs is a complex, time-consuming, and expensive process, often involving hundreds of individual steps. Errors in even one step have the potential to result in defects in the finished IC rendering it useless. Thus, one goal of the manufacturing process is to avoid such defects to maximize the number of functional ICs made in the process, that is, to improve the overall yield of the process.

One component of improving yield is monitoring the chip making process to ensure that it is producing a sufficient number of functional integrated circuits. One way to monitor the process is to inspect the chip circuit structures at various stages of their formation. Inspection may be carried out using a scanning electron microscope (SEM). A SEM can be used to image these extremely small structures, in effect, taking a “picture” of the structures of the wafer. The image can be used to determine if the structure was formed properly and also if it was formed at the proper location. If the structure is defective, then the process can be adjusted so the defect is less likely to recur. Defects may be generated during various stages of semiconductor processing. For the reason stated above, it is important to find defects accurately, efficiently, and as early as possible.

The working principle of a SEM is similar to a camera. A camera takes a picture by receiving and recording brightness and colors of light reflected or emitted from people or objects. A SEM takes a “picture” by receiving and recording energies or quantities of electrons reflected or emitted from the structures. Before taking such a “picture,” an electron beam may be provided onto the structures, and when the electrons are reflected or emitted (“exiting”) from the structures, a detector of the SEM may receive and record the energies or quantities of those electrons to generate an image. To take such a “picture,” some SEMs use a single electron beam (referred to as a “single-beam SEM”), while some SEMs use multiple electron beams (referred to as a “multi-beam SEM”) to take multiple “pictures” of the wafer. By using multiple electron beams, the SEM may provide more electron beams onto the structures for obtaining these multiple “pictures,” resulting in more electrons exiting from the structures. Accordingly, the detector may receive more exiting electrons simultaneously, and generate images of the structures of the wafer with a higher efficiency and a faster speed.

For example, voltage contrast inspection may be used as an early proxy for electric yield associated with a sample. SEM images including voltage contrast patterns typically show a random occurrence of failures associated with features of a sample (e.g., varying grey scale levels of features). For example, grey level intensity levels in an SEM inspection image may deviate from grey level intensity levels in a defect-free SEM image, thereby indicating that a sample associated with the SEM inspection image includes one or more defects (e.g., electrical open or short failures). In some embodiments, other characteristics (e.g., besides or in addition to voltage contrast characteristics) in an SEM inspection image may deviate from a defect-free SEM image (e.g., characteristics related to line-edge roughness, line-width roughness, local critical dimension uniformity, necking, bridging, edge placement errors, etc.), thereby indicating that a sample associated with the SEM inspection image includes one or more defects.

A system may perform a distortion correction on a SEM inspection image and align the SEM inspection image with a template image to detect one or more defects on an inspected sample. For example, one or more defects on the inspected sample may be detected by comparing the aligned SEM images to a plurality of reference images (e.g., comparing an inspection image to two defect-free images of a sample during die-to-die inspection).

However, even after performing a distortion correction on a SEM inspection image, image analysis during inspection suffers from constraints. Because a sample may have many defects, a SEM inspection image may differ greatly from a template SEM image, resulting in misalignment of the SEM inspection image and the template image.

Moreover, a plurality of reference images may be used to detect one or more defects under an assumption that defects occur randomly and rarely, thereby reducing the possibility that the reference images include the same defects as the inspection image. However, it is not uncommon for reference images to include the same defects as the inspection image. When reference images include defects (e.g., the same defects as the inspection image or other defects), a system may fail to identify real defects in the inspection image or the system may fail to use characteristics of the inspection image (e.g., physical features such as bridges) due to noisy data.

Due to misalignment of the inspection image and the template image, systems are not able to accurately identify or index locations of defects on a sample (e.g., image analysis algorithms may fail during image alignment).

Relative dimensions of components in drawings may be exaggerated for clarity. Within the following description of drawings, the same or like reference numbers refer to the same or like components or entities, and only the differences with respect to the individual embodiments are described.

As used herein, unless specifically stated otherwise, the term “or” encompasses all possible combinations, except where infeasible. For example, if it is stated that a component may include A or B, then, unless specifically stated otherwise or infeasible, the component may include A, or B, or A and B. As a second example, if it is stated that a component may include A, B, or C, then, unless specifically stated otherwise or infeasible, the component may include A, or B, or C, or A and B, or A and C, or B and C, or A and B and C.

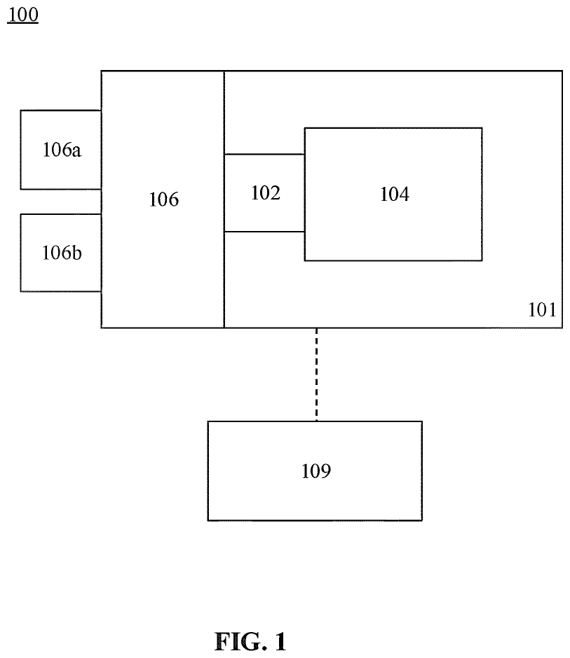

FIG. 1 illustrates an exemplary electron beam inspection (EBI) system 100 consistent with embodiments of the present disclosure. EBI system 100 may be used for imaging. As shown in FIG. 1, EBI system 100 includes a main chamber 101, a load/lock chamber 102, an electron beam tool 104, and an equipment front end module (EFEM) 106. Electron beam tool 104 is located within main chamber 101. EFEM 106 includes a first loading port 106a and a second loading port 106b. EFEM 106 may include additional loading port(s). First loading port 106a and second loading port 106b receive wafer front opening unified pods (FOUPs) that contain wafers (e.g., semiconductor wafers or wafers made of other material(s)) or samples to be inspected (wafers and samples may be used interchangeably). A “lot” is a plurality of wafers that may be loaded for processing as a batch.

One or more robotic arms (not shown) in EFEM 106 may transport the wafers to load/lock chamber 102. Load/lock chamber 102 is connected to a load/lock vacuum pump system (not shown) which removes gas molecules in load/lock chamber 102 to reach a first pressure below the atmospheric pressure. After reaching the first pressure, one or more robotic arms (not shown) may transport the wafer from load/lock chamber 102 to main chamber 101. Main chamber 101 is connected to a main chamber vacuum pump system (not shown) which removes gas molecules in main chamber 101 to reach a second pressure below the first pressure. After reaching the second pressure, the wafer is subject to inspection by electron beam tool 104. Electron beam tool 104 may be a single-beam system or a multi-beam system.

A controller 109 is electronically connected to electron beam tool 104. Controller 109 may be a computer configured to execute various controls of EBI system 100. While controller 109 is shown in FIG. 1 as being outside of the structure that includes main chamber 101, load/lock chamber 102, and EFEM 106, it is appreciated that controller 109 may be a part of the structure.

In some embodiments, controller 109 may include one or more processors (not shown). A processor may be a generic or specific electronic device capable of manipulating or processing information. For example, the processor may include any combination of any number of a central processing unit (or “CPU”), a graphics processing unit (or “GPU”), an optical processor, a programmable logic controllers, a microcontroller, a microprocessor, a digital signal processor, an intellectual property (IP) core, a Programmable Logic Array (PLA), a Programmable Array Logic (PAL), a Generic Array Logic (GAL), a Complex Programmable Logic Device (CPLD), a Field-Programmable Gate Array (FPGA), a System On Chip (SoC), an Application-Specific Integrated Circuit (ASIC), and any type circuit capable of data processing. The processor may also be a virtual processor that includes one or more processors distributed across multiple machines or devices coupled via a network.

In some embodiments, controller 109 may further include one or more memories (not shown). A memory may be a generic or specific electronic device capable of storing codes and data accessible by the processor (e.g., via a bus). For example, the memory may include any combination of any number of a random-access memory (RAM), a read-only memory (ROM), an optical disc, a magnetic disk, a hard drive, a solid-state drive, a flash drive, a security digital (SD) card, a memory stick, a compact flash (CF) card, or any type of storage device. The codes may include an operating system (OS) and one or more application programs (or “apps”) for specific tasks. The memory may also be a virtual memory that includes one or more memories distributed across multiple machines or devices coupled via a network.

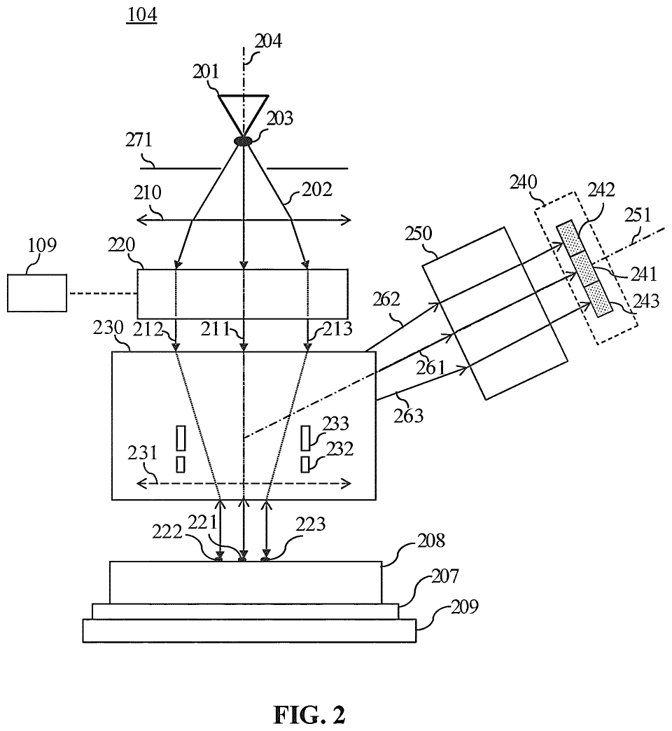

Reference is now made to FIG. 2, which is a schematic diagram illustrating an exemplary electron beam tool 104 including a multi-beam inspection tool that is part of the EBI system 100 of FIG. 1, consistent with embodiments of the present disclosure. In some embodiments, electron beam tool 104 may be operated as a single-beam inspection tool that is part of EBI system 100 of FIG. 1. Multi-beam electron beam tool 104 (also referred to herein as apparatus 104) comprises an electron source 201, a Coulomb aperture plate (or “gun aperture plate”) 271, a condenser lens 210, a source conversion unit 220, a primary projection system 230, a motorized stage 209, and a sample holder 207 supported by motorized stage 209 to hold a sample 208 (e.g., a wafer or a photomask) to be inspected. Multi-beam electron beam tool 104 may further comprise a secondary projection system 250 and an electron detection device 240. Primary projection system 230 may comprise an objective lens 231. Electron detection device 240 may comprise a plurality of detection elements 241, 242, and 243. A beam separator 233 and a deflection scanning unit 232 may be positioned inside primary projection system 230.

Electron source 201, Coulomb aperture plate 271, condenser lens 210, source conversion unit 220, beam separator 233, deflection scanning unit 232, and primary projection system 230 may be aligned with a primary optical axis 204 of apparatus 104. Secondary projection system 250 and electron detection device 240 may be aligned with a secondary optical axis 251 of apparatus 104.

Electron source 201 may comprise a cathode (not shown) and an extractor or anode (not shown), in which, during operation, electron source 201 is configured to emit primary electrons from the cathode and the primary electrons are extracted or accelerated by the extractor and/or the anode to form a primary electron beam 202 that form a primary beam crossover (virtual or real) 203. Primary electron beam 202 may be visualized as being emitted from primary beam crossover 203.

Source conversion unit 220 may comprise an image-forming element array (not shown), an aberration compensator array (not shown), a beam-limit aperture array (not shown), and a pre-bending micro-deflector array (not shown). In some embodiments, the pre-bending micro-deflector array deflects a plurality of primary beamlets 211, 212, 213 of primary electron beam 202 to normally enter the beam-limit aperture array, the image-forming element array, and an aberration compensator array. In some embodiments, apparatus 104 may be operated as a single-beam system such that a single primary beamlet is generated. In some embodiments, condenser lens 210 is designed to focus primary electron beam 202 to become a parallel beam and be normally incident onto source conversion unit 220. The image-forming element array may comprise a plurality of micro-deflectors or micro-lenses to influence the plurality of primary beamlets 211, 212, 213 of primary electron beam 202 and to form a plurality of parallel images (virtual or real) of primary beam crossover 203, one for each of the primary beamlets 211, 212, and 213. In some embodiments, the aberration compensator array may comprise a field curvature compensator array (not shown) and an astigmatism compensator array (not shown). The field curvature compensator array may comprise a plurality of micro-lenses to compensate field curvature aberrations of the primary beamlets 211, 212, and 213. The astigmatism compensator array may comprise a plurality of micro-stigmators to compensate astigmatism aberrations of the primary beamlets 211, 212, and 213. The beam-limit aperture array may be configured to limit diameters of individual primary beamlets 211, 212, and 213. FIG. 2 shows three primary beamlets 211, 212, and 213 as an example, and it is appreciated that source conversion unit 220 may be configured to form any number of primary beamlets. Controller 109 may be connected to various parts of EBI system 100 of FIG. 1, such as source conversion unit 220, electron detection device 240, primary projection system 230, or motorized stage 209. In some embodiments, as explained in further details below, controller 109 may perform various image and signal processing functions. Controller 109 may also generate various control signals to govern operations of the charged particle beam inspection system.

Condenser lens 210 is configured to focus primary electron beam 202. Condenser lens 210 may further be configured to adjust electric currents of primary beamlets 211, 212, and 213 downstream of source conversion unit 220 by varying the focusing power of condenser lens 210. Alternatively, the electric currents may be changed by altering the radial sizes of beam-limit apertures within the beam-limit aperture array corresponding to the individual primary beamlets. The electric currents may be changed by both altering the radial sizes of beam-limit apertures and the focusing power of condenser lens 210. Condenser lens 210 may be an adjustable condenser lens that may be configured so that the position of its first principal plane is movable. The adjustable condenser lens may be configured to be magnetic, which may result in off-axis beamlets 212 and 213 illuminating source conversion unit 220 with rotation angles. The rotation angles change with the focusing power or the position of the first principal plane of the adjustable condenser lens. Condenser lens 210 may be an anti-rotation condenser lens that may be configured to keep the rotation angles unchanged while the focusing power of condenser lens 210 is changed. In some embodiments, condenser lens 210 may be an adjustable anti-rotation condenser lens, in which the rotation angles do not change when its focusing power and the position of its first principal plane are varied.

Objective lens 231 may be configured to focus beamlets 211, 212, and 213 onto a sample 208 for inspection and may form, in the current embodiments, three probe spots 221, 222, and 223 on the surface of sample 208. Coulomb aperture plate 271, in operation, is configured to block off peripheral electrons of primary electron beam 202 to reduce Coulomb effect. The Coulomb effect may enlarge the size of each of probe spots 221, 222, and 223 of primary beamlets 211, 212, 213, and therefore deteriorate inspection resolution.

Beam separator 233 may, for example, be a Wien filter comprising an electrostatic deflector generating an electrostatic dipole field and a magnetic dipole field (not shown in FIG. 2). In operation, beam separator 233 may be configured to exert an electrostatic force by electrostatic dipole field on individual electrons of primary beamlets 211, 212, and 213. The electrostatic force is equal in magnitude but opposite in direction to the magnetic force exerted by magnetic dipole field of beam separator 233 on the individual electrons. Primary beamlets 211, 212, and 213 may therefore pass at least substantially straight through beam separator 233 with at least substantially zero deflection angles.

Deflection scanning unit 232, in operation, is configured to deflect primary beamlets 211, 212, and 213 to scan probe spots 221, 222, and 223 across individual scanning areas in a section of the surface of sample 208. In response to incidence of primary beamlets 211, 212, and 213 or probe spots 221, 222, and 223 on sample 208, electrons emerge from sample 208 and generate three secondary electron beams 261, 262, and 263. Each of secondary electron beams 261, 262, and 263 typically comprise secondary electrons (having electron energy ≤50 eV) and backscattered electrons (having electron energy between 50 eV and the landing energy of primary beamlets 211, 212, and 213). Beam separator 233 is configured to deflect secondary electron beams 261, 262, and 263 towards secondary projection system 250. Secondary projection system 250 subsequently focuses secondary electron beams 261, 262, and 263 onto detection elements 241, 242, and 243 of electron detection device 240. Detection elements 241, 242, and 243 are arranged to detect corresponding secondary electron beams 261, 262, and 263 and generate corresponding signals which are sent to controller 109 or a signal processing system (not shown), e.g., to construct images of the corresponding scanned areas of sample 208.

In some embodiments, detection elements 241, 242, and 243 detect corresponding secondary electron beams 261, 262, and 263, respectively, and generate corresponding intensity signal outputs (not shown) to an image processing system (e.g., controller 109). In some embodiments, each detection element 241, 242, and 243 may comprise one or more pixels. The intensity signal output of a detection element may be a sum of signals generated by all the pixels within the detection element.

In some embodiments, controller 109 may comprise image processing system that includes an image acquirer (not shown), a storage (not shown). The image acquirer may comprise one or more processors. For example, the image acquirer may comprise a computer, a server, a mainframe host, terminals, a personal computer, any kind of mobile computing devices, and the like, or a combination thereof. The image acquirer may be communicatively coupled to electron detection device 240 of apparatus 104 through a medium such as an electrical conductor, an optical fiber cable, a portable storage media, IR, Bluetooth, internet, a wireless network, a wireless radio, among others, or a combination thereof. In some embodiments, the image acquirer may receive a signal from electron detection device 240 and may construct an image. The image acquirer may thus acquire images of sample 208. The image acquirer may also perform various post-processing functions, such as generating contours, superimposing indicators on an acquired image, and the like. The image acquirer may be configured to perform adjustments of brightness and contrast, etc. of acquired images. In some embodiments, the storage may be a storage medium such as a hard disk, flash drive, cloud storage, random access memory (RAM), other types of computer readable memory, and the like. The storage may be coupled with the image acquirer and may be used for saving scanned raw image data as original images, and post-processed images.

In some embodiments, the image acquirer may acquire one or more images of a sample based on an imaging signal received from electron detection device 240. An imaging signal may correspond to a scanning operation for conducting charged particle imaging. An acquired image may be a single image comprising a plurality of imaging areas. The single image may be stored in the storage. The single image may be an original image that may be divided into a plurality of regions. Each of the regions may comprise one imaging area containing a feature of sample 208. The acquired images may comprise multiple images of a single imaging area of sample 208 sampled multiple times over a time sequence. The multiple images may be stored in the storage. In some embodiments, controller 109 may be configured to perform image processing steps with the multiple images of the same location of sample 208.

In some embodiments, controller 109 may include measurement circuitries (e.g., analog-to-digital converters) to obtain a distribution of the detected secondary electrons. The electron distribution data collected during a detection time window, in combination with corresponding scan path data of each of primary beamlets 211, 212, and 213 incident on the wafer surface, can be used to reconstruct images of the wafer structures under inspection. The reconstructed images can be used to reveal various features of the internal or external structures of sample 208, and thereby can be used to reveal any defects that may exist in the wafer.

In some embodiments, controller 109 may control motorized stage 209 to move sample 208 during inspection of sample 208. In some embodiments, controller 109 may enable motorized stage 209 to move sample 208 in a direction continuously at a constant speed. In other embodiments, controller 109 may enable motorized stage 209 to change the speed of the movement of sample 208 overtime depending on the steps of scanning process.

Although FIG. 2 shows that apparatus 104 uses three primary electron beams, it is appreciated that apparatus 104 may use two or more number of primary electron beams. The present disclosure does not limit the number of primary electron beams used in apparatus 104. In some embodiments, apparatus 104 may be a SEM used for lithography, defect inspection, or a combination thereof.

Compared with a single charged-particle beam imaging system (“single-beam system”), a multiple charged-particle beam imaging system (“multi-beam system”) may be designed to optimize throughput for different scan modes. Embodiments of this disclosure provide a multi-beam system with the capability of optimizing throughput for different scan modes by using beam arrays with different geometries. adapting to different throughputs and resolution requirements.

A non-transitory computer readable medium may be provided that stores instructions for a processor (e.g., processor of controller 109 of FIGS. 1-2) to carry out image processing, data processing, beamlet scanning, database management, graphical display, operations of a charged particle beam apparatus, or another imaging device, or the like. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same.

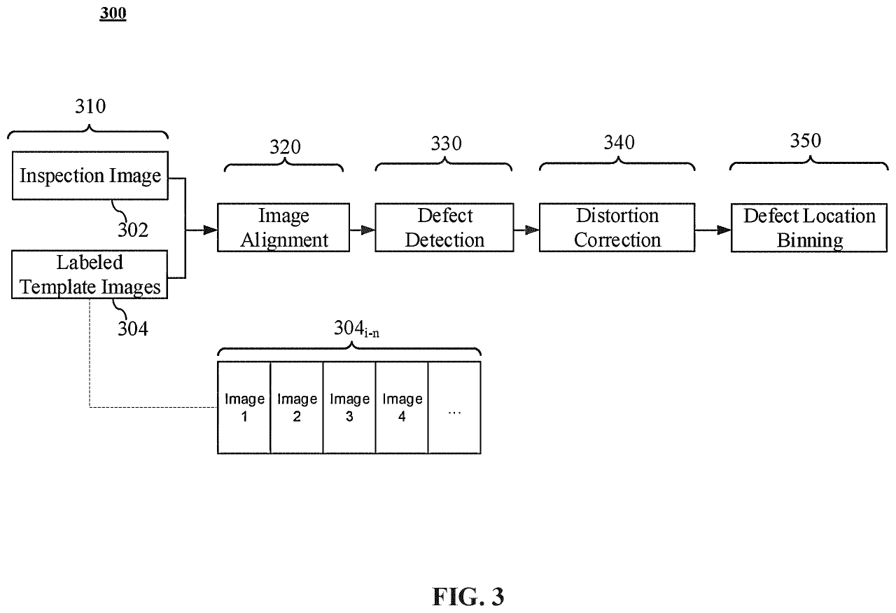

Reference is now made to FIG. 3, which illustrates a flowchart representing an exemplary image analysis method. An image analysis process 300, as shown in FIG. 3, is often used to detect one or more defects and identify the location of the detected defects on a sample.

At step 310, an inspection system (e.g., EBI system 100 of FIG. 1) may obtain an inspection image 302 (e.g., a SEM image generated during inspection of a sample) and a template image 304. For example, a template image may be a defect-free SEM image of a sample. A template image may include one or more regions of a sample in a field-of-view (FOV). Template image 304 may include one or more manually labeled high-resolution reference SEM images 304ᵢ₋ₙ. For example, a user may capture multiple high-resolution SEM images of a region of a sample using an inspection system and manually label a position of a feature based on the mask information.

At step 320, inspection image 302 is aligned with a labeled template image 304 including at least one or more features of inspection image. In some cases, a processor of inspection system may perform the alignment of images to identify the locations of one or more defects on a sample being inspected.

At step 330, inspection system detects one or more defects on an inspection sample by comparing the aligned images to a plurality of reference images (e.g., comparing an inspection image to two defect-free images of a sample during die-to-die inspection).

At step 340, inspection system performs distortion correction on inspection image 302. Distortion in inspection image 302 may occur because of several reasons including, but not limited to, system operating conditions, tooling factors, calibrations, sample processing history, among other factors. However, even after performing a distortion correction on the inspection image, image analysis using process 300 suffers from constraints. Because a sample may have many defects, the inspection image may differ greatly from a template image to which the inspection image is compared, resulting in misalignment of the inspection image and the template image.

Moreover, a plurality of reference images (e.g., reference images 304ᵢ₋ₙ) may be used to detect one or more defects under an assumption that defects occur randomly and rarely, thereby reducing the possibility that the reference images include the same defects as the inspection image. However, it is not uncommon for reference images to include the same defects as the inspection image. When reference images include defects (e.g., the same defects as the inspection image or other defects), a system may fail to identify real defects in the inspection image or the system may fail to use characteristics of the inspection image (e.g., physical features such as bridges) due to noisy data.

At step 350, a location binning module of inspection system may index the identified one or more locations of defects on the sample (e.g., by binning or categorizing locations or positions of defects on a sample). For example, indexing the identified one or more locations of defects on a sample may include labeling a position of a feature with a defect with respect to a sample (e.g., row index, column index, row number, column number, etc.).

There may be several challenges in identifying and binning defects using a manually labeled template image 304 in process 300, such as generating a representative template image, misalignment of the inspection image and the template image, etc. Generating a labeled representative template image may include several steps such as, but not limited to, collecting multiple high-resolution SEM images of a region of interest, drawing mask information associated with the region of interest, counting column numbers and row numbers, and labeling features accordingly. One or more of these steps are performed manually by a user or a group of users, making the process inefficient, cumbersome, and error-prone. In some instances, the region of interest may not be covered by a single SEM reference image and one or more reference images may be “stitched” or combined to adequately represent the region of interest. This may make the process more inefficient and inconsistent. Further, once imaged, the inspection area, scan width, scan rate, inspection modes, etc. of the captured reference SEM images cannot be changed. Furthermore, one or more reference SEM images may suffer from drift and distortion aberrations caused partly by surface-charging, which can severely impact spatial resolution and critical dimension measurements. Although digital image correction techniques may be employed to address the drift and distortion artifacts, such techniques are time-consuming and may further introduce variability and negatively impact inspection throughput. Therefore, it may be desirable to provide a system and method for image analysis including auto-generated template images based on predetermined mask design layout and substantially distortion-free reference images.

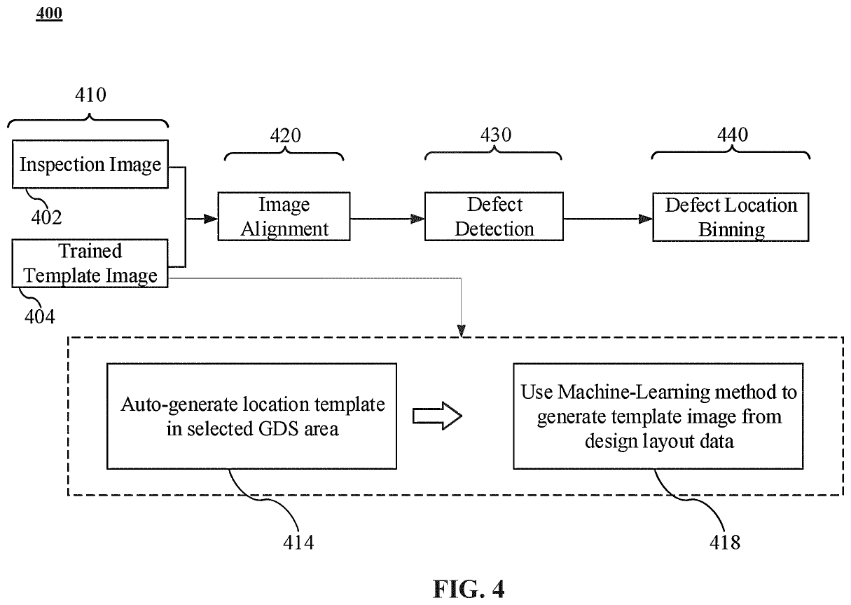

Reference is now made to FIG. 4, which illustrates a flowchart representing an exemplary image analysis method, consistent with embodiments of the present disclosure. In some embodiments, one or more steps of image analysis process 400, also referred to herein as process 400, may be performed by EBI system 100 of FIG. 1, a processor associated with EBI system 100, and a location binning module associated with EBI system 100. One or more steps, not illustrated in FIG. 4, may be added, deleted, edited, or ordered differently, as appropriate.

In step 410, an inspection system or an apparatus such as EBI system 100 may acquire an inspection image 402 of a portion of a sample (e.g., sample 208 of FIG. 2), or a defect of interest (DOI), or a region of interest (ROI) of the sample. Inspection image 402 may comprise a low-resolution SEM image, a high-resolution SEM image, or a backscattered electron image, acquired using EBI system 100. In some embodiments, inspection image 402 may be acquired in a continuous scan mode (CS mode), a hot spot mode (HS mode), or a link scan mode (LS mode), or other appropriate inspection modes.

In some embodiments, process 400 may include determining one or more attributes of inspection image 402. Determining an attribute may comprise identifying a feature of an image of the sample based on a location of the feature, a size of the feature, a pattern, or other characteristics. In some embodiments, identifying a feature may involve knowledge of the process steps, device type, process conditions, among other factors. In some embodiments, attributes of inspection image 402 may further include, but are not limited to, magnification, scan width, scan area, scan rate, resolution, among other things.

Step 410 of process 400 may further include generating a trained template image 404. In some embodiments, trained template image 404 may comprise a reference image simulated using a machine learning model, for example. Trained template image 404 may be generated based on mask layout information corresponding to the identified feature of inspection image 402 or corresponding to an identified region of interest represented by inspection image 402. In some embodiments, trained template image 404 image may include one or more regions of a sample in a FOV. In some embodiments, trained template image 404 may include user-defined data (e.g., locations of features on a sample). In some embodiments, trained template image 404 may be rendered from layout design data. For example, a layout design of a sample may be stored in a layout file for a wafer design. The layout file can be in a Graphic Database System (GDS) format, Graphic Database System II (GDS II) format, an Open Artwork System Interchange Standard (OASIS) format, a Caltech Intermediate Format (CIF), etc. The wafer design may include patterns or structures for inclusion on the wafer. The patterns or structures can be mask patterns used to transfer features from the photolithography masks or reticles to a wafer. In some embodiments, a layout in GDS or OASIS format, among others, may comprise feature information stored in a binary file format representing planar geometric shapes, text, and other information related to the wafer design. In some embodiments, a layout design may correspond to a FOV of an inspection system. In some embodiments, a layout design may be selected based on inspected samples (e.g., based on layouts that have been identified on a sample).

In some embodiments, generating trained template image 404 may comprise generating a location template in the GDS mask layout or design layout, represented as step 414 in FIG. 4. A location template in the GDS mask layout may be generated automatically. In the context of this disclosure, “automatically” refers to a method of performing an operation with minimal or no manual intervention and mostly controlled or implemented using a machine. In this example, an automatically generating a location template refers to identifying, without input from a user and using a software-implemented algorithm, a location template within the GDS design layout based on the identified feature of the inspection image.

Generating trained template image 404 may further comprise generating a trained template SEM image based on the location template, represented as step 416 in FIG. 4, using a combination of the GDS layout data and one or more reference SEM images. In some embodiments, the machine learning model may be trained using at least one reference SEM image or a set of reference SEM images. For example, training the model may include mapping the GDS mask information to corresponding features in the SEM reference images. In some embodiments, a SEM reference image may be a high-resolution image substantially free of defects obtained using an inspection apparatus such as EBI system 100. The machine learning model, upon training, may be configured to generate template SEM images from GDS mask information data. Trained template image 404 may be substantially noise-free, substantially defect-free, or substantially distortion-free images. In the context of this disclosure, “substantially noise-free image” refers to an image having negligible levels of noise, “substantially defect-free image” refers to an image having a negligible, undetectably small number of defects, and “substantially distortion-free image” refers to negligible amount of distortion causing minimal to no loss of spatial resolution across the image.

Step 420 of process 400 may include aligning an inspection image (e.g., inspection image 402) with a template image (e.g., trained template image 404). A processor or a system (e.g., EBI 100 of FIG. 1) may be configured to align inspection image 402 and trained template image 404 such that a location of a feature of inspection image 402 corresponds to the location of the feature on the template image 404 based on GDS layout data. In some embodiments, performing alignment of inspection image and template image may serve to verify a location, a size, or other attributes of one or more features of the identified region of inspection image 402. For example, a comparison or an alignment of an inspection image of a region of interest of sample with the corresponding template image generated based on GDS layout data may determine whether a feature is present at an expected location, or if the size of the feature is within tolerance, or other characteristics associated with the feature.

Step 430 of process 400 may include detecting defects and identifying a location of the defects in inspection image 402 with respect to template image 404. In some embodiments, inspection image 402 may include one or more defects including, but not limited to, electrical defects such as electrical opens, electrical shorts, current leakage paths, or physical defects such as necking, bridging, edge placement errors, holes, broken lines, etc. In some embodiments, for example, defects in an inspection image may have certain intensity levels (e.g., levels of “brightness” or “darkness” grey levels of voltage contrast images) that are different from defect-free characteristics, identified as “bright” features. While a defect may be identified as a “dark” feature, it should be understood that defects may be illustrated as various grey levels or other characteristics (e.g., line-edge roughness, line-width roughness, local critical dimension uniformity, necking, bridging, edge placement errors, holes, broken lines, etc.).

Step 440 of process 400 may include binning locations of one or more defects identified in step 430. In some embodiments, location binning of defects of inspection image 402 may include indexing the identified one or more locations of defects on a sample. Indexing may include labeling a position of feature with a defect with respect to a sample with a column index and a row index, or a column number and a row number.

Image analysis process (e.g., process 400) using trained template images based on GDS layout data may have numerous advantages over existing image analysis process (e.g., process 300) in improving accuracy and throughput of defect detection, among other things. Image analysis process using machine learning model trained template SEM images may have some or all of the advantages discussed herein:
1. Distortion-free template images—A trained machine learning model configured to generate template SEM images based on GDS layout data allows the template images to be free of distortion. In the proposed image analysis method, the GDS-based template images are simulated using a trained machine learning or a neural network model, which is not influenced by the operating tool conditions and aberrations associated with the inspection apparatus.
2. Enhanced template image compatibility—The GDS-based simulated template images may be compatible with a variety of inspection systems with different scan widths, scan lengths, and multiple scan modes. For example, the location template in the GDS layout data is configurable by a user and may be generated based on the identified region of interest. On the other hand, in conventional image analysis methods, the scan area, scan rate, or scan modes of template images are fixed and cannot be adjusted.
3. Defect-free and noise-free template images—In addition to being distortion-free, GDS-based template images or trained template images may be defect-free and noise-free as well, which may allow accurate detection and location identification of defects.
4. Higher defect inspection throughput—The conventional image analysis method using manually labeled template images requires collection of a large set of high-resolution images of regions of interest at different conditions and scan parameters. The location binning requires manually drawing a template in the inspection image and manually labeling defects or features of interest. Such process steps are inefficient and error-prone. On the other hand, image analysis based on comparison of an inspection image with a machine learning trained template image based on GDS layout information may enhance the overall throughput and accuracy.

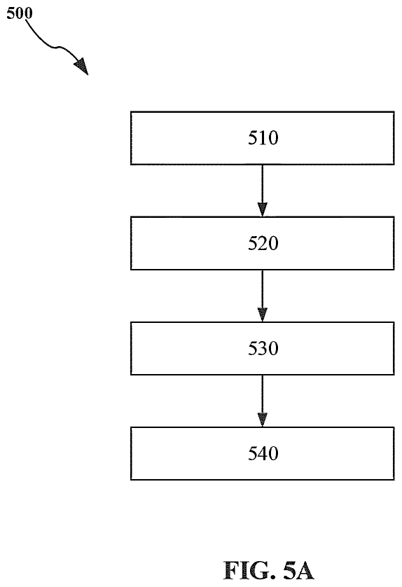

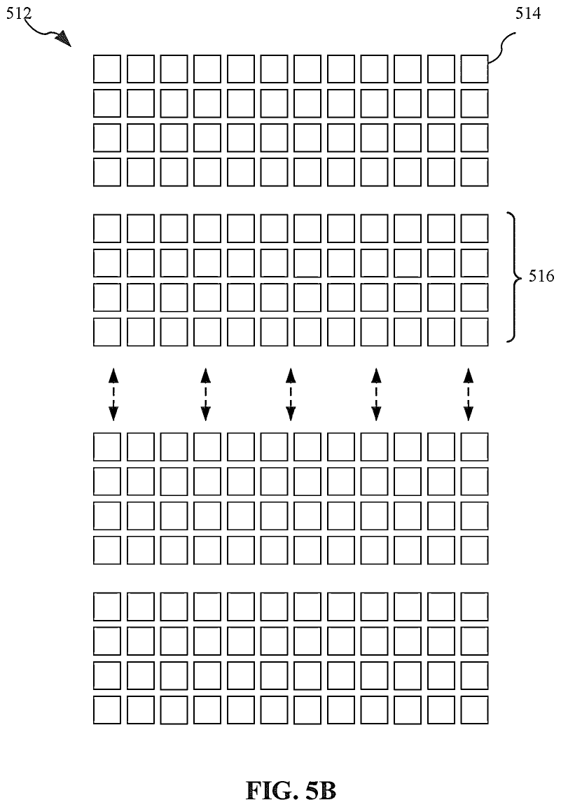

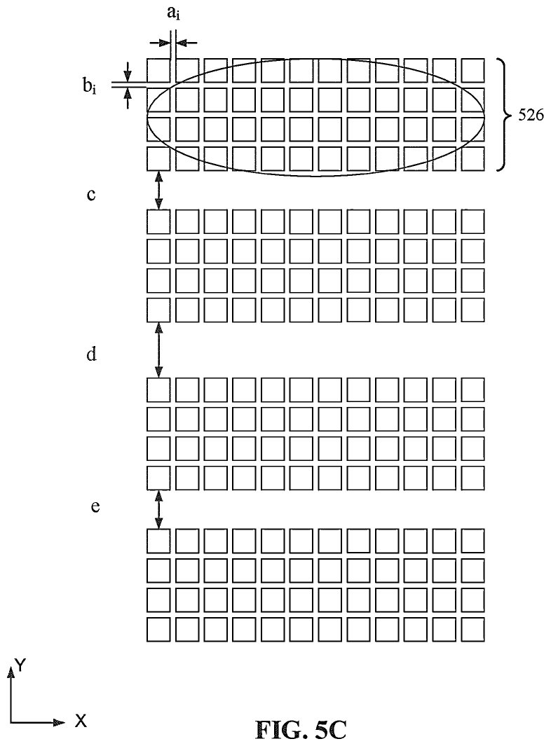

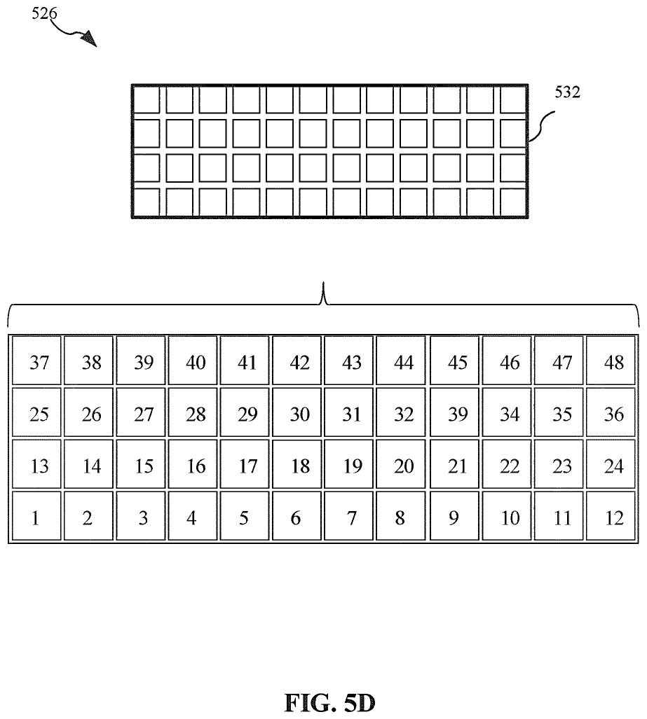

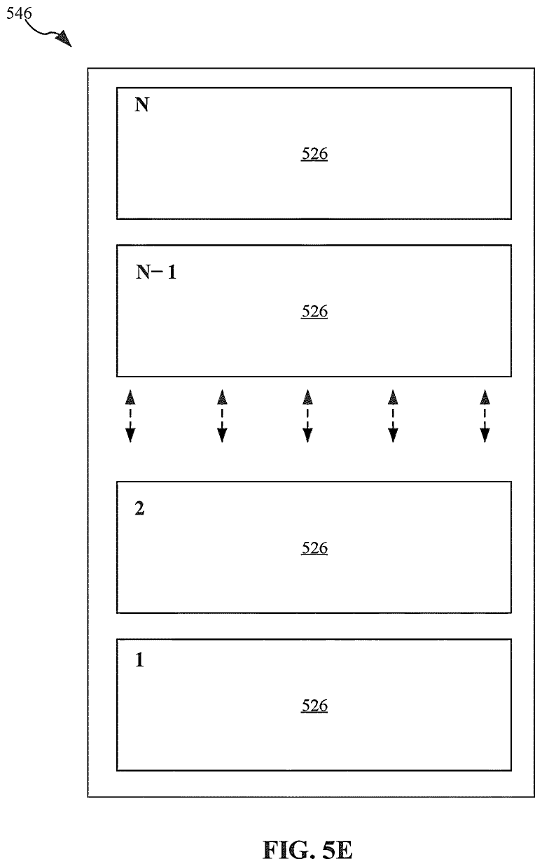

Reference is now made to FIG. 5A, which illustrates a flowchart of process 500 for generating an exemplary location template in a GDS design layout, consistent with embodiments of the present disclosure. The process for generating a location template may include the steps of obtaining GDS layout information (step 510), grouping features (e.g., polygons) of GDS layout information (step 520), forming boundary coordinates (step 530), and generating a location template (step 540). It is to be appreciated that one or more of the steps of process 500 may be implemented by a processor (e.g., processor of controller 109), a system, or a module of a system such that the location template is generated automatically, without human intervention.

In step 510, a processor or a system may obtain layout information such as GDS layout information, from a database or a storage module configured to store mask layout information. In some embodiments, the processor or the system may be configured to obtain GDS layout information or data of a region corresponding to the one or more features identified in inspection image 402. GDS layout information may include data associated with location coordinates of features, mask IDs, process IDs, among other data usable to identify the feature or the region of the sample containing the feature. In some embodiments, the processor or the system may be configured to obtain GDS layout or GDS pattern that includes at least one identified feature of inspection image 402. An exemplary GDS pattern 512 obtained by the system or the processor is shown in FIG. 5B.

As illustrated in FIG. 5B, GDS pattern 512 may include features 514. Although features 514 are illustrated as polygons and GDS pattern 512 shows a polygon pattern, it is to be appreciated that GDS pattern 512 may comprise a hole pattern, a line pattern, among other patterns. In some embodiments, GDS pattern may represent the mask pattern associated with the identified region of the sample in inspection image. In some embodiments, GDS pattern 512 may include a plurality of features arranged in an array of unit structures 516, each unit structure 516 including an array of features 514. In some embodiments, unit structure 516 may include one or more different features such as a hole, a line, a polygon, or a combination thereof. GDS pattern 512 may include a one-dimensional or a two-dimensional array of unit structures 516.

In step 520, a processor or a system may group features 514 (e.g., polygons in FIG. 5A) into a repeating pattern based on a distance between adjacent features 514 in the X-direction, in the Y-direction, or both. As illustrated, the gap or the distance in the Y-direction between unit structures 516 may be represented as c, d, or e. In some embodiments, the distance in Y-direction between adjacent unit structures 516 may be uniform or non-uniform. Though not shown, in a two-dimensional array of unit structures in GDS pattern 512, the distance in the X-direction between adjacent unit structures may be uniform or non-uniform.

In some embodiments, the distance between adjacent features 514 in the X-direction, denoted as “at” and the distance between adjacent features 514 in the Y-direction, denoted as “bᵢ” may be uniform or non-uniform. In this context, “adjacent feature” in the Y-direction refers to a feature directly and vertically above or below a feature, and in the X-direction refers to an immediately neighboring feature to the left or right of a feature.

In some embodiments, features 514 may be grouped based on the distance between features and unit structures to form a grouped repeating pattern 526, as shown in FIG. 5C. In some embodiments, the distance between features and unit structures may be defined by a user. For example, a user may define values for aᵢ, bᵢ, c, d, or e and may also define a relationship between one or more of these parameters. In a two-dimensional array of unit structures 516, a user may define the gap-distance relationship for one or more images or regions of interest. As an example, a user may set boundary conditions to form a group of features, where aᵢ<c and bᵢ<c, or aᵢ<d and bᵢ<d, or aᵢ<e and bᵢ<e, or aᵢ<c and bᵢ=c or d or e. It is to be appreciated that though not shown or mentioned, other configurations and user-defined configurations may be possible.

In step 530, a processor or a system may determine boundary coordinates and boundary contour 532 of a grouped repeating pattern 526, as illustrated in FIG. 5D. Grouped repeating pattern 526 may include a plurality of features 514 which satisfy the boundary conditions defined by a user based on inspection image, or a predetermined set of boundary conditions. In some embodiments, boundary contour 532 of grouped repeating pattern 526 may be determined using a computational geometric algorithm such as, but not limited to, a convex hull algorithm. It is to be appreciated that other algorithms may be used as well, as appropriate.

In some embodiments, a processor or a system may index location of features 514 in grouped repeating pattern 526, also referred to herein as a block. Indexing may include labeling a feature with a feature identifier or a tier index identifier. As an example, tier index 18 may be located in column number 6 and row number 2, or column index 6 and row index 2. FIG. 5D shows an enlarged view of block 526 including indexed features arranged in 12 columns and 4 rows. In some embodiments, features of block 526 or a location in block 526 may be indexed based on a distance from one or more edges of boundary contour 532 or a defined mask edge, which may be obtained from the GDS layout information. In some embodiments, features of block 526 may be identified by location coordinates in the x- and y-axes. The location coordinates may be based on a relative distance from a predefined edge of boundary contour 532.

In some embodiments, a system or a processor may index the identified one or more locations of features on the sample (e.g., bin or categorize locations or positions of features on sample). For example, indexing the identified one or more locations may help with identifying positions of defects on a sample based on a comparison of the inspection image (e.g., inspection image 402) and the trained template image (e.g., trained template image 404). If a defect is detected on the inspection image relative to the trained template image, the labeling of a position of a feature (e.g., group identifiers, block identifiers, first via in the first row, fourteenth via in the third row, etc.) from the trained template image that corresponds to the defect can be stored for location binning

In step 540, a system or a processor may generate location template 546 based on GDS layout information, after grouping and indexing. Location template 546 may include a N number of arrayed grouped repeating patterns 526, as illustrated in FIG. 5E. As previously described, characteristics of a grouped repeating pattern 526 may be configured by a user or predetermined. Location template 546 may include a region of GDS mask layout which includes at least one feature of inspection image 402. In some embodiments, the information associated with location template 546 may be stored in a database or a storage module of a system such as EBI system 100 of FIG. 1. Information associated with location template 546 may include coordinates data, size and position of features, size and position of grouped repeating patterns, spacing between features, spacing between unit structures, spacing between grouped repeating patterns, number of grouped repeating patterns, number of features, feature shapes, among other data.

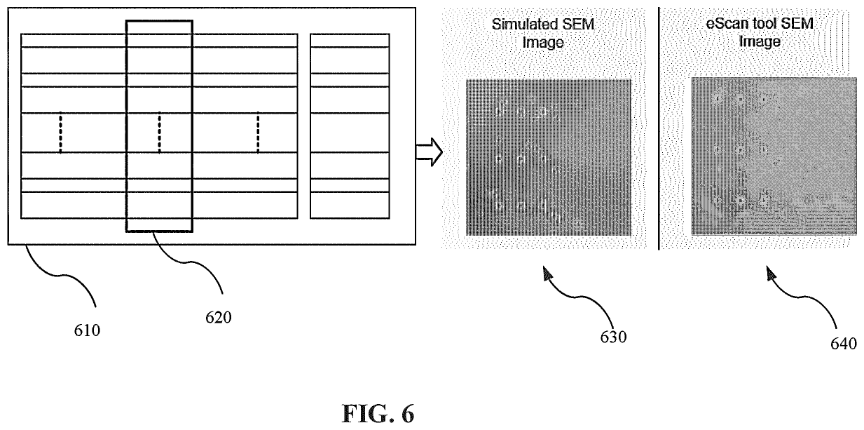

Reference is now made to FIG. 6, which illustrates a schematic diagram of an exemplary simulated template image generated from a GDS location template, consistent with embodiments of the present disclosure.

FIG. 6 illustrates a schematic of an exemplary automatically generated location template 610 in GDS layout. Location template 610 may be substantially similar to location template 546 of FIG. 5E and may be generated by, for example, process 500 of FIG. 5A. It is to be appreciated that process 500 is an exemplary process and steps may be added, deleted, reordered, or modified, as appropriate. In some embodiments, location template 610 may include at least one or more features of inspection image 402 or may represent a region of interest based on inspection image 402. In some embodiments, region of interest may include one or more defects and location indexing or binning of location template may be used in binning the identified one or more defects in an inspection image.

As illustrated in FIG. 6, a region of interest 620 may be determined by a system or a processor. A machine learning model or a deep convolutional neural network model may be trained to generate a simulated SEM image 630 from identified region of interest 620. A machine learning model may be trained by mapping one or more features from GDS layout information to corresponding one or more features of inspected images such as, high-resolution SEM reference images 640 obtained using an inspection system (e.g., apparatus 104 of FIG. 2). In comparison with the conventional image analysis technique, a smaller set of inspected reference images may be needed to train the machine learning model because the machine learning model is trained based on a combination of the GDS layout information and a corresponding reference image.

In training the machine learning model, reference images of a mask pattern or a reticle pattern may be used as the model input and the truth information may comprise aligned SEM images. The features such as, a hole pattern, a line pattern, or a polygon, of a mask may be represented by “bright” regions and the non-patterned areas of a mask may be represented by “dark” regions. The training of machine learning model may include feeding multiple SEM images of one or more mask regions from the GDS layout pattern to create a database of reference simulated SEM images. In some alternative embodiments, features of a mask may be represented by “dark” regions and non-patterned areas of a mask may be represented by “bright” regions. It is to be appreciated that a detectable difference in gray levels of patterned and non-patterned areas of a mask may be used as well to train the machine learning model with SEM images of the masks.

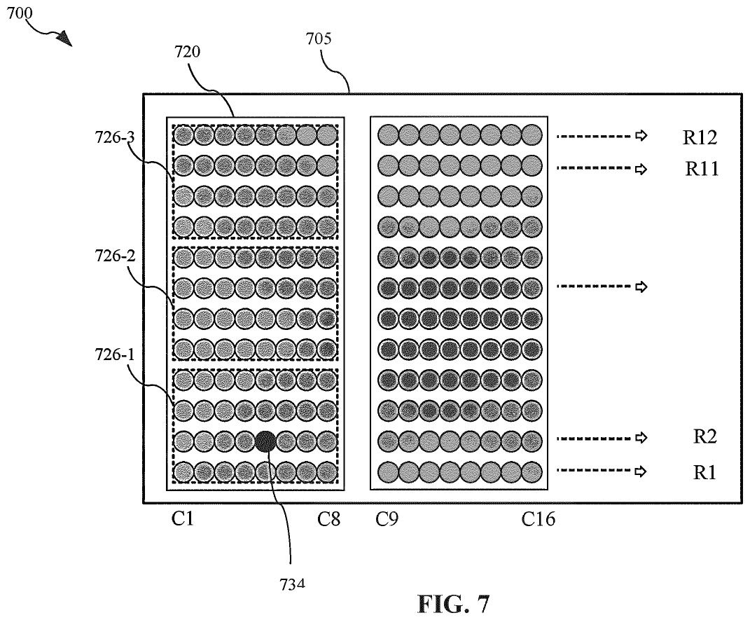

Reference is now made to FIG. 7, which illustrates a schematic of an exemplary GDS layout of a mask, consistent with embodiments of the present disclosure. GDS layout 700 may include a mask pattern 705, location template 720 including one or more grouped repeating patterns 726, and each grouped repeating pattern 726 including a plurality of features. It is to be appreciated that although mask pattern 705 illustrates a hole pattern, other patterns may be present as well.

In some embodiments, machine learning model may be trained using one or more SEM images of mask pattern 705 and the corresponding GDS layout information. The machine learning model may be trained to generate a template SEM image of one or more regions of mask pattern 705. In some embodiments, one or more grouped repeating patterns 726 may include a feature of interest 734 as identified by the system based on one or more attributes of inspection image. As an example, feature of interest 734 may be indexed as column 5 row 2 in grouped repeating pattern 726-1. Upon alignment with an inspection image, as described in step 420 of FIG. 4, if a defect is identified in a region of inspection image 402 corresponding to the region of interest 734, the defect may be binned accordingly.

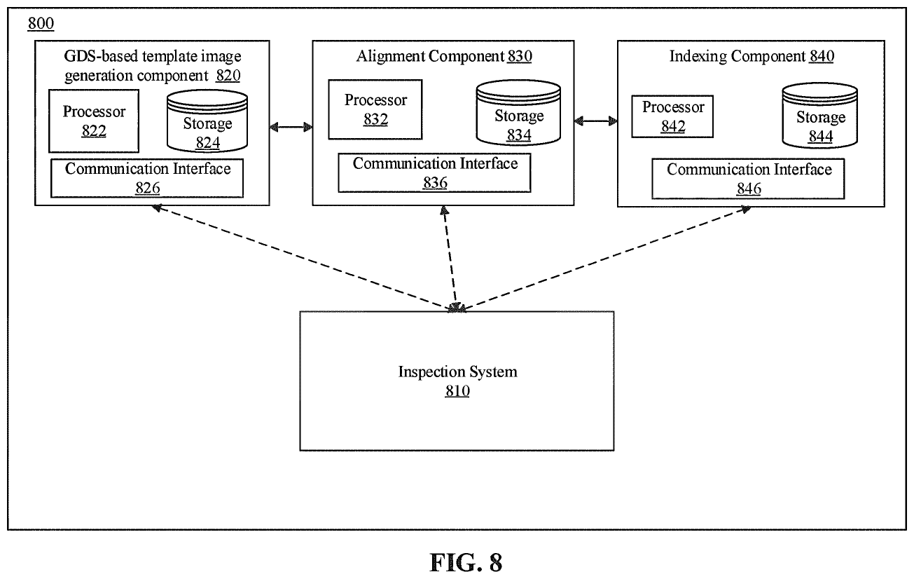

FIG. 8 is a schematic diagram of a system for defect detection and defect location binning, consistent with embodiments of the present disclosure. System 800 may include an inspection system 810, GDS-based template image generation component 820, an alignment component 830, and an indexing component 840. Inspection system 810, restoration and defect detection component 820, alignment component 830, and indexing component 840 may be electrically coupled (directly or indirectly) to each other, either physically (e.g., by a cable) or remotely. Inspection system 810 may be the system described with respect to FIGS. 1 and 2, used to acquire images of a wafer (see, e.g., sample 208 of FIG. 2). In some embodiments, components of system 800 may be implemented as one or more servers (e.g., where each server includes its own processor). In some embodiments, components of system 800 may be implemented as software that may obtain data from one or more databases of system 800. In some embodiments, system 800 may include one server or a plurality of servers. In some embodiments, system 800 may include one or more modules that are implemented by a controller (e.g., controller 109 of FIG. 1, controller 109 of FIG. 2).

Inspection system 810 may transmit data including inspection images of a sample (e.g., sample 208 of FIG. 2) to one or more components of system 800.

GDS-based template image generation 820 may include a processor 822 and a storage 824. Component 820 may also include a communication interface 826 to send data to alignment component 830. Processor 822 may be configured to perform one or more functions including, but not limited to, identifying one or more features of inspection image, training machine learning model based on GDS layout information, generating a location template in the GDS layout information, among other things. In some embodiments, processor 822 may be configured to generate location templates which include at least one or more identified regions of interest from inspection image. Processor 822 may be further configured to generate grouped repeating patterns, or generate boundary contours, or index a grouped repeating pattern.

Alignment component 830 may include a processor 832 and a storage 834. Alignment component 830 may also include a communication interface 826 to send data to indexing component 840. Processor 832 may be configured to align a trained template image (e.g., trained template image 404 of FIG. 4) with an inspection image (e.g., inspection image 402 of FIG. 4). For example, processor 832 may be configured to align an inspection image with a machine learning model simulated reference image. Using the alignment, processor 832 may be configured to identify one or more locations of one or more defect in inspection image based on the GDS based template image simulated by the machine learning model. The identified locations of one or more defects may be binned based on the indexing of the location template in the GDS file.

For example, a reference image may be a defect-free image of a sample. In some embodiments, a reference image may include one or more regions of a sample in a FOV. In some embodiments, a reference image may include user-defined data (e.g., locations of features on a sample). In some embodiments, a reference image may be a golden image (e.g., a high-resolution, defect-free image). In some embodiments, a reference image may be rendered from layout design data or a simulated image from a trained machine learning model.

Alignment component 830 may transmit data including identified locations of the inspection image to indexing component 840.

Indexing component 840 may include a processor 842 and a storage 844. Indexing component 840 may also include a communication interface 846 to receive data from alignment component 830. Processor 842 may be configured to index the identified one or more locations of defects on the sample (e.g., bin or categorize locations or positions of defects on sample). For example, indexing the identified one or more locations of defects on a sample may include labeling a position of a feature with a defect with respect to a sample (e.g., first via in the first row, fourteenth via in the third row, etc.).

Advantageously, due to the alignment of the inspection image and the template image, processor 842 may be configured to accurately identify and index locations of defects on a sample.

A non-transitory computer readable medium may be provided that stores instructions for a processor of a controller (e.g., controller 109 of FIG. 1) for controlling the electron beam tool, consistent with embodiments in the present disclosure. For example, instructions may include obtaining an inspection image of a sample, identifying a feature or an attribute of the inspection image, generating a template image based on GDS layout information, generating a location template in the GDS layout, or aligning the template mage with an inspection image. Common forms of non-transitory media include, for example, a floppy disk, a flexible disk, hard disk, solid state drive, magnetic tape, or any other magnetic data storage medium, a Compact Disc Read Only Memory (CD-ROM), any other optical data storage medium, any physical medium with patterns of holes, a Random Access Memory (RAM), a Programmable Read Only Memory (PROM), and Erasable Programmable Read Only Memory (EPROM), a FLASH-EPROM or any other flash memory, Non-Volatile Random Access Memory (NVRAM), a cache, a register, any other memory chip or cartridge, and networked versions of the same.

The embodiments may further be described using the following clauses:
1. A method of image analysis, the method comprising:
obtaining an image of a sample;
identifying a feature captured in the image of the sample;
generating a template image from a design layout of the identified feature;
comparing the image of the sample with the template image; and
processing the image based on the comparison.
2. The method of clause 1, wherein generating the template image comprises:
generating a location template in the design layout, the location template representing a portion of the obtained image; and
generating the template image based on the location template.
3. The method of any one of clauses 1 and 2, wherein generating the template image further comprises: training a machine learning model by mapping information associated with the design layout to information associated with a reference image; and generating a simulated template image using the trained machine learning model.
4. The method of any one of clauses 2 and 3, wherein generating the location template comprises: identifying a region of the design layout corresponding to the portion of the obtained image; and
grouping a plurality of features in the identified region into one or more repeating patterns at least based on a distance between adjacent features of the plurality of features.
5. The method of clause 4, wherein generating the location template further comprises determining boundary coordinates of the one or more repeating patterns.
6. The method of clause 5, wherein the boundary coordinates of the one or more repeating patterns are configurable.
7. The method of any one of clauses 4-6, further comprising indexing a location of the plurality of features in the one or more repeating patterns.
8. The method of clause 7, further comprising storing information associated with the boundary coordinates of the one or more repeating patterns and information associated with the indexed location of the plurality of features in the one or more repeating patterns.
9. The method of any one of clauses 1-8, wherein comparing the image of the sample with the template image comprises:
aligning the image of the sample with the template image; and
identifying a set of locations of any one or more defects in the obtained image of the sample.
10. The method of clause 9, wherein the any one or more defects indicate any one of necking, bridging, edge placement error, hole, or a broken line.
11. The method of any one of clauses 9 and 10, wherein processing the image based on the comparison further comprises binning the set of locations of the any one or more defects based on a location of one or more corresponding features on the template image.
12. The method of any one of clauses 2-11, wherein the template image comprises a simulated scanning electron microscopy (SEM) image of a region of the location template corresponding to the obtained image.
13. The method of clause 12, wherein the simulated SEM image is substantially distortion-free.
14. The method of any one of clauses 3-13, wherein the reference image comprises an inspected scanning electron microscopy (SEM) image.
15. A system for image analysis, comprising:
a controller including circuitry configured to cause the system to perform:
obtaining an image of a sample;
identifying a feature captured in the image of the sample;
generating a template image from a design layout of the identified feature;
comparing the image of the sample with the template image; and
processing the image based on the comparison.
16. The system of clause 15, wherein generating the template image comprises:
generating a location template in the design layout, the location template representing a portion of the obtained image; and
generating the template image based on the location template.
17. The system of any one of clauses 15 and 16, wherein generating the template image further comprises:
training a machine learning model by mapping information associated with the design layout to information associated with a reference image; and
generating a simulated template image using the trained machine learning model.
18. The system of any one of clauses 16 and 17, wherein generating the location template comprises:
identifying a region of the design layout corresponding to the portion of the obtained image; and
grouping a plurality of features in the identified region into one or more repeating patterns at least based on a distance between adjacent features of the plurality of features.
19. The system of clause 18, wherein generating the location template further comprises determining boundary coordinates of the one or more repeating patterns.
20. The system of clause 19, wherein the boundary coordinates of the one or more repeating patterns are configurable.
21. The system of any one of clauses 18-20, wherein the controller is configured to cause the system to further perform indexing a location of the plurality of features in the one or more repeating patterns.
22. The system of clause 21, wherein the controller is configured to cause the system to further perform storing information associated with the boundary coordinates of the one or more repeating patterns and information associated with the indexed location of the plurality of features in the one or more repeating patterns.
23. The system of any one of clauses 15-22, wherein comparing the image of the sample with the template image comprises:
aligning the image of the sample with the template image; and
identifying a set of locations of any one or more defects in the obtained image of the sample.
24. The system of clause 23, wherein the any one or more defects indicate any one of necking, bridging, edge placement error, hole, or a broken line.
25. The system of any one of clauses 23 and 24, wherein processing the image based on the comparison further comprises binning the set of locations of the any one or more defects based on a location of one or more corresponding features on the template image.
26. The system of any one of clauses 16-25, wherein the template image comprises a simulated scanning electron microscopy (SEM) image of a region of the location template corresponding to the obtained image.
27. The system of clause 26, wherein the simulated SEM image is substantially distortion-free.
28. The system of any one of clauses 17-27, wherein the reference image comprises an inspected scanning electron microscopy (SEM) image.
29. A non-transitory computer readable medium that stores a set of instructions that is executable by one or more processors of a computing device to cause the computing device to perform a method for image analysis, the method comprising:
obtaining an image of a sample;
identifying a feature captured in the image of the sample;
generating a template image from a design layout of the identified feature;
comparing the image of the sample with the template image; and
processing the image based on the comparison.
30. The non-transitory computer readable medium of clause 29, wherein generating the template image comprises:
generating a location template in the design layout, the location template representing a portion of the obtained image; and
generating the template image based on the location template.
31. The non-transitory computer readable medium of any one of clauses 29 and 30, wherein generating the template image further comprises:
training a machine learning model by mapping information associated with the design layout to information associated with a reference image; and
generating a simulated template image using the trained machine learning model.
32. The non-transitory computer readable medium of any one of clauses 30 and 31, wherein generating the location template comprises:
identifying a region of the design layout corresponding to the portion of the obtained image; and
grouping a plurality of features in the identified region into one or more repeating patterns at least based on a distance between adjacent features of the plurality of features of the plurality of features.
33. The non-transitory computer readable medium of clause 32, wherein generating the location template further comprises determining boundary coordinates of the one or more repeating patterns.
34. The non-transitory computer readable medium of clause 33, wherein the boundary coordinates of the one or more repeating patterns are configurable.
35. The non-transitory computer readable medium of any one of clauses 32-34, wherein the set of instructions that is executable by the one or more processors of the computing device causes the computing device to further perform indexing a location of the plurality of features in the one or more repeating patterns.
36. The non-transitory computer readable medium of clause 35, wherein the set of instructions that is executable by the one or more processors of the computing device causes the computing device to further perform storing information associated with the boundary coordinates of the one or more repeating patterns and information associated with the indexed location of the plurality of features in the one or more repeating patterns.
37. The non-transitory computer readable medium of any one of clauses 29-36, wherein comparing the image of the sample with the template image comprises:
aligning the image of the sample with the template image; and
identifying a set of locations of any one or more defects in the obtained image of the sample.
38. The non-transitory computer readable medium of clause 37, wherein the any one or more defects indicate any one of necking, bridging, edge placement error, hole, or a broken line.
39. The non-transitory computer readable medium of any one of clauses 37 and 38, wherein processing the image based on the comparison further comprises binning the set of locations of the any one or more defects based on a location of one or more corresponding features on the template image.
40. The non-transitory computer readable medium of any one of clauses 30-39, wherein the template image comprises a simulated scanning electron microscopy (SEM) image of a region of the location template corresponding to the obtained image.
41. The non-transitory computer readable medium of clause 40, wherein the simulated SEM image is substantially distortion-free.
42. The non-transitory computer readable medium of any one of clauses 31-41, wherein the reference image comprises an inspected scanning electron microscopy (SEM) image.
43. A method of image analysis, the method comprising:
obtaining an image of a sample;
identifying a feature captured in the obtained image of the sample;
mapping the obtained image to a template image generated from a design layout of the identified feature; and
analyzing the image based on the mapping.
44. The method of clause 43, wherein the template image is generated by:
generating a location template in the design layout, the location template representing a portion of the obtained image; and
generating the template image based on the location template.
45. The method of clause 44, wherein generating the location template comprises:
identifying a region of the design layout corresponding to the portion of the obtained image; and
grouping a plurality of features in the identified region into one or more repeating patterns at least based on a distance between adjacent features of the plurality of features.
46. The method of any one of clauses 43-45, wherein analyzing the image based on the mapping comprises:
aligning the image of the sample with the template image; and
identifying a set of locations of any one or more defects in the obtained image of the sample.
47. The method of clause 46, wherein the any one or more defects indicate any one of necking, bridging, edge placement error, hole, or a broken line.
48. The method of any one of clauses 43-47, wherein mapping the obtained image to the template image comprises correlating the set of locations of any one or more defects in the obtained image to a location of one or more corresponding features on the template image.
49. The method of any one of clauses 43-48, further comprising storing information associated with the mapping of the obtained image to the template image.
50. The method of any one of clauses 43-49, further comprising storing information associated with the analysis based on the mapping.
51. A system for image analysis, comprising:
a controller including circuitry configured to cause the system to perform:
obtaining an image of a sample;
identifying a feature captured in the obtained image of the sample;
mapping the obtained image to a template image generated from a design layout of the identified feature; and
analyzing the image based on the mapping.
52. The system of clause 51, wherein generating the template image comprises:
generating a location template in the design layout, the location template representing a portion of the obtained image; and
generating the template image based on the location template.
53. The system of clause 52, wherein generating the location template comprises:
identifying a region of the design layout corresponding to the portion of the obtained image; and
grouping a plurality of features in the identified region into one or more repeating patterns at least based on a distance between adjacent features of the plurality of features.
54. The system of any one of clauses 51-53, wherein analyzing the image based on the mapping comprises:
aligning the image of the sample with the template image; and
identifying a set of locations of any one or more defects in the obtained image of the sample.
55. The system of clause 54, wherein the any one or more defects indicate any one of necking, bridging, edge placement error, hole, or a broken line.
56. The system of any one of clauses 51-55, wherein mapping the obtained image to the template image comprises correlating the set of locations of any one or more defects in the obtained image to a location of one or more corresponding features on the template image.
57. The system of any one of clauses 51-56, wherein the controller is configured to cause the system to further perform storing information associated with the mapping of the obtained image to the template image.
58. The system of any one of clauses 51-57, wherein the controller is configured to cause the system to further perform storing information associated with the analysis based on the mapping.
59. A non-transitory computer readable medium that stores a set of instructions that is executable by at one or more processors of a computing device to cause the computing device to perform a method for image analysis, the method comprising:
obtaining an image of a sample;
identifying a feature captured in the obtained image of the sample;
mapping the obtained image to a template image generated from a design layout of the identified feature; and
analyzing the image based on the mapping.
60. The non-transitory computer readable medium of clause 59, wherein generating the template image comprises:
generating a location template in the design layout, the location template representing a portion of the obtained image; and
generating the template image based on the location template
61. The non-transitory computer readable medium of clause 60, wherein generating the location template comprises:
identifying a region of the design layout corresponding to the portion of the obtained image; and
grouping a plurality of features in the identified region into one or more repeating patterns at least based on a distance between adjacent features of the plurality of features.
62. The non-transitory computer readable medium of any one of clauses 59-61, wherein analyzing the image based on the mapping comprises:
aligning the image of the sample with the template image; and
identifying a set of locations of any one or more defects in the obtained image of the sample.
63. The non-transitory computer readable medium of clause 62, wherein the any one or more defects indicate any one of necking, bridging, edge placement error, hole, or a broken line.
64. The non-transitory computer readable medium of any one of clauses 59-63, wherein mapping the obtained image to the template image comprises correlating the set of locations of any one or more defects in the obtained image to a location of one or more corresponding features on the template image.
65. The non-transitory computer readable medium of any one of clauses 59-64, wherein the set of instructions that is executable by at the one or more processors of the computing device causes the computing device to further perform storing information associated with the mapping of the obtained image to the template image.
66. The non-transitory computer readable medium of any one of clauses 59-65, wherein the set of instructions that is executable by at the one or more processors of the computing device causes the computing device to further perform storing information associated with the analysis based on the mapping.

It will be appreciated that the embodiments of the present disclosure are not limited to the exact construction that has been described above and illustrated in the accompanying drawings, and that various modifications and changes may be made without departing from the scope thereof. The present disclosure has been described in connection with various embodiments, other embodiments of the invention will be apparent to those skilled in the art from consideration of the specification and practice of the invention disclosed herein. It is intended that the specification and examples be considered as exemplary only, with a true scope and spirit of the invention being indicated by the following claims.

The descriptions above are intended to be illustrative, not limiting. Thus, it will be apparent to one skilled in the art that modifications may be made as described without departing from the scope of the claims set out below.

1. A non-transitory computer readable medium that stores a set of instructions that is executable by one or more processors of a computing device to cause the computing device to perform a method for image analysis, the method comprising:
obtaining an image of a sample;
identifying a feature captured in the image of the sample;
generating a template image from a design layout of the identified feature;
comparing the image of the sample with the template image; and
processing the image based on the comparison.

2. The non-transitory computer readable medium of claim 1, wherein generating the template image comprises:
generating a location template in the design layout, the location template representing a portion of the obtained image; and
generating the template image based on the location template.

3. The non-transitory computer readable medium of claim 1, wherein generating the template image further comprises:
training a machine learning model by mapping information associated with the design layout to information associated with a reference image; and
generating a simulated template image using the trained machine learning model.

4. The non-transitory computer readable medium of claim 2, wherein generating the location template comprises:
identifying a region of the design layout corresponding to the portion of the obtained image; and
grouping a plurality of features in the identified region into one or more repeating patterns at least based on a distance between adjacent features of the plurality of features of the plurality of features.

5. The non-transitory computer readable medium of claim 4, wherein generating the location template further comprises determining boundary coordinates of the one or more repeating patterns.

6. The non-transitory computer readable medium of claim 5, wherein the boundary coordinates of the one or more repeating patterns are configurable.

7. The non-transitory computer readable medium of claim 4, wherein the set of instructions that is executable by the one or more processors of the computing device causes the computing device to further perform indexing a location of the plurality of features in the one or more repeating patterns.

8. The non-transitory computer readable medium of claim 7, wherein the set of instructions that is executable by the one or more processors of the computing device causes the computing device to further perform storing information associated with boundary coordinates of the one or more repeating patterns and information associated with the indexed location of the plurality of features in the one or more repeating patterns.

9. The non-transitory computer readable medium of claim 1, wherein comparing the image of the sample with the template image comprises:
aligning the image of the sample with the template image; and
identifying a set of locations of any one or more defects in the obtained image of the sample.

10. The non-transitory computer readable medium of claim 9, wherein the any one or more defects indicate any one of necking, bridging, edge placement error, hole, or a broken line.

11. The non-transitory computer readable medium of claim 9, wherein processing the image based on the comparison further comprises binning the set of locations of the any one or more defects based on a location of one or more corresponding features on the template image.

12. The non-transitory computer readable medium of claim 2, wherein the template image comprises a simulated scanning electron microscopy (SEM) image of a region of the location template corresponding to the obtained image.

13. The non-transitory computer readable medium of claim 12, wherein the simulated SEM image is substantially distortion-free.

14. The non-transitory computer readable medium of claim 3, wherein the reference image comprises an inspected scanning electron microscopy (SEM) image.

15. A system for image analysis, comprising:
a controller including circuitry configured to cause the system to perform:
obtaining an image of a sample;
identifying a feature captured in the image of the sample;
generating a template image from a design layout of the identified feature;
comparing the image of the sample with the template image; and
processing the image based on the comparison.

16. The system of claim 15, wherein generating the template image comprises:
generating a location template in the design layout, the location template representing a portion of the obtained image; and
generating the template image based on the location template.

17. The system of claim 15, wherein generating the template image further comprises:
training a machine learning model by mapping information associated with the design layout to
information associated with a reference image; and
generating a simulated template image using the trained machine learning model.

18. The system of claim 16, wherein generating the location template comprises:
identifying a region of the design layout corresponding to the portion of the obtained image; and
grouping a plurality of features in the identified region into one or more repeating patterns at least
based on a distance between adjacent features of the plurality of features.

19. The system of claim 18, wherein generating the location template further comprises determining boundary coordinates of the one or more repeating patterns.

20. The system of claim 19, wherein the boundary coordinates of the one or more repeating patterns are configurable.
